(19) United States
(12) Patent Application Publication
(10) Pub. No.: US 2010/0145716 A1
(43) Pub. Date: Jun. 10, 2010

(54) Carbon sequestration via wood burial and storage

(76) Inventor: Ning Zeng, University Park, MD (US)

Correspondence Address: JONATHAN E. GRANT/GRANT PATENT SERVICES, 2107 HOUNDS RUN PLACE, SILVER SPRING, MD, 20906, US

(21) Appl. No.: 12/314,309

(22) Filed: Dec. 8, 2008

(51) Int. Cl. G06Q 99/00; B01D 53/84

(52) U.S. Cl. 705/1.1; 423/220; 705/500

(57) ABSTRACT

To mitigate global climate change, a portfolio of strategies will be needed to keep the atmospheric CO₂ concentration below a dangerous level. Here a carbon sequestration strategy is proposed in which certain dead or live trees are harvested via collection or selective cutting, then buried in trenches or stowed away in above-ground shelters. The largely anaerobic condition under a sufficiently thick layer of soil will prevent the decomposition of the buried wood. Because a large flux of CO₂ is constantly being assimilated into the world's forests via photosynthesis, cutting off its return pathway to the atmosphere forms an effective carbon sink.

### FIELD OF THE DISCLOSURE

A system is disclosed for managing forests in order to sequester carbon.

### BACKGROUND OF THE DISCLOSURE

Atmospheric CO₂ concentration has increased from 280 to 380 ppmv (parts per million by volume; a 35% change) since pre-industrial time, largely due to carbon emissions from anthropogenic fossil fuel burning and deforestation (IPCC (2007), Climate Change 2007, Cambridge University Press, incorporated herein by reference). The emission rate of carbon from fossil fuel (oil, coal and gas) consumption is currently about 8 GtC y⁻¹ (10¹⁵ g of carbon per year (Canadell, J. G., et al. (2007), From the Cover: Contributions to accelerating atmospheric CO2 growth from economic activity, carbon intensity, and efficiency of natural sinks, Proceedings of the National Academy of Sciences, 104(47), 18866-18870, incorporated herein by reference) while the deforestation rate for the 1990s is estimated to be 1.6 (0.5-2.7) GtC y⁻¹. The cumulative fossil fuel emission since 1860 is 330 GtC, but only about half of that remains in the atmosphere; the remainder absorbed by carbon sinks in the ocean and on land (IPCC 2007, supra).

Fossil fuel emissions are projected to reach 9-20 GtC y⁻¹ by 2050 in the absence of climate change policies, according to a range of emissions scenarios (Nakicenovic, N., et al. (2000), Special Report on Emissions Scenarios, Cambridge University Press, incorporated herein by reference).

Depending on how the current carbon sinks change in the future, the atmospheric CO₂ concentration for the Special Report on Emissions Scenarios (SRES) A2 emissions scenario is between 450-600 ppmv by 2050, and 700-1000 ppmv by 2100, and global mean surface temperature may increase between 1.5-5.5° C. (Friedlingstein, P., et al. (2006), Climate-carbon cycle feedback analysis: Results from the C4MIP model intercomparison, Journal of Climate, 19(14), 3337-3353, incorporated herein by reference) with related changes in sea-level, extreme events, and ecosystem shifts. Scientists have argued that severe consequences will occur once atmospheric CO₂ concentrations reach between 450 and 600 ppmv (Hansen, J. E. (2005), A slippery slope: How much global warming constitutes “dangerous anthropogenic interference”?, (Climatic Change, 68(3), 269-279; O'Neill, B. C., and M. Oppenheimer (2004), Climate change impacts are sensitive to the concentration stabilization path, Proceedings of the National Academy of Sciences of the United States of America, 101(47), 16411-16416; Schneider, S. H., and M. D. Mastrandrea (2005), Probabilistic assessment “dangerous” climate change and emissions pathways, Proceedings of the National Academy of Sciences of the United States of America, 102(44), 15728-15735, all incorporated by reference) Beyond this point, global climate change would be very difficult and costly to deal with (Stern, N. (2007), The Economics of Climate Change, Cambridge University Press, Cambridge, UK, incorporated herein by reference).

Keeping the atmospheric CO₂ concentration below 450-600 ppmv poses an unprecedented challenge to humanity. There are two main approaches: (1) to reduce emissions; (2) to capture CO₂ and store it, i.e., sequestration. Since our economy depends heavily on fossil fuel, which comprises more than 80% of primary energy use, to reduce carbon emissions requires drastic changes in energy use efficiency and the use of alternative energy sources that are generally not economically competitive at present [Hoffert, M. I., et al. (2002), Advanced technology paths to global climate stability: Energy for a greenhouse planet, Science, 298(5595), 981-987 Hoffert et al., 2002; Pacala, S., and R. Socolow (2004), Stabilization wedges: Solving the climate problem for the next 50 years with current technologies, Science, 305(5686), 968-972, incorporated herein by reference).

Carbon sequestration involves two steps: (1) CO₂ capture, either from the atmosphere or at industrial sources; (2) storage. Capture out of the atmosphere is assumed to be much more expensive because of the low CO₂ concentration in the atmosphere relative to N₂ and O₂. For this reason, most current proposals seek to combine capturing CO₂ with power generation, with several pilot power plants planned or underway (Schrag, D. P. (2007), Preparing to capture carbon, Science, 315(5813), 812-813, incorporated herein by reference.)

The proposals for storing captured CO₂ include pumping it into deep ocean where CO₂ may react with water under the high pressure to form methane hydrates (Brewer, P. G., et al. (1999), Direct experiments on the ocean disposal of fossil fuel CO2, Science, 284(5416), 943-945, incorporated herein by reference) or stays in CO₂ lakes, burying carbon inside deep ocean sediments where conditions are even more stable than ocean bottom (House, K. Z., et al. (2006), Permanent carbon dioxide storage in deep-sea sediments, Proc. Natl. Acad. Sci. U.S.A., 103(33), 12291-12295, incorporated herein by reference) The technique that has been most seriously considered, is to store captured CO₂ in geological formations such as old mines and deep saline aquifers (IPCC (2005), Special Report: Carbon Dioxide Capture and Storage, Cambridge University Press, incorporated herein by reference).

There is also a spectrum of biospheric carbon sequestration methods, such as enhancing oceanic plankton productivity by iron fertilization, reforestation or altering forestry and agricultural management practices to maximize carbon stored in soil and vegetation, but the potential and permanence of these biospheric techniques have been unclear.

Even if advanced technologies such as hydrogen power and nuclear fusion become economical, the infrastructure switch will take many decades. It is thus very likely that at least some carbon sequestration will be needed in the near future to keep CO₂ below a dangerous level.

### SUMMARY OF THE DISCLOSURE

An alternative method for controlling CO₂ is to use a biospheric carbon sequestration approach wherein wood from old or dead trees in the world's forests is harvested and buried in trenches under a layer of soil, where the anaerobic condition slows the decomposition of the buried wood. This can be supplemented by selective cutting of other suitable trees. On the storage side, high-quality wood can also be stored in shelters for future use. In this technique, CO₂ capture is done by the natural process of photosynthesis, and storage is low tech and distributed, thus attractive in two important aspects: cost and safety.

The possibility of carbon sequestration via wood burial stems from the observation that natural forest is typically littered with dead trees (FIG. 1). It is hypothesized that large quantities of organic carbon were buried and preserved for over one hundred thousand years under the great Northern Hemisphere ice sheets during the Pleistocene glacial-interglacial cycles. (Zeng, N. (2003), Glacial-interglacial atmospheric CO2 change—The glacial burial hypothesis, Advances in Atmospheric Sciences, 20(5), 677-693; Zeng, N. (2007), Quasi-100 key glacial-interglacial cycles triggered by subglacial burial carbon release, Clim. Past., 3(1), 135-153, herein incorporated by reference).

Other studies have shown that organic matter, especially wood, in municipal landfills decomposes extremely slowly (Micales, J. A., and K. E. Skog (1997), The decomposition of forest products in landfills, International Biodeterioration & Biodegradation, 39(2-3), 145-158, herein incorporated by reference). With these, it became clear that wood harvesting and burial could be a viable method for carbon sequestration.

Globally, approximately 60 GtC y⁻¹ are temporarily sequestered by land vegetation (Net Primary Productivity or NPP; FIG. 2). This carbon is continuously returned to the atmosphere when vegetation dies and decomposes (heterotrophic respiration, Rₕ). In a steady state, the death rates of these carbon components equal to their respective decomposition rates and add up to NPP such that the net land-atmosphere carbon flux is near zero (NPP=Rₕ). If implemented, the processes discussed here can stop or slow down a part of the decomposition pathway, and CO₂ can be sequestered at a rate that may rival the current fossil CO₂ emission of 8 GtC y⁻¹. Since woody material is most resistant to decomposition due to its lignin-cellulose fiber structure which also minimizes nutrient lock-up (below), it is important to focus on the carbon pools.

Two major questions need to be first answered concerning the potential of this method: what is the production rate of dead wood, and how much is there in the world's forests? Unfortunately, there is a general lack of knowledge of dead wood on the forest floor, and this carbon pool is often neglected in carbon budget accounting. Since death rate is fundamentally limited by growth rate, the dead wood production rate can not exceed the world total NPP of 60 GtC y⁻¹. Then the key question is how NPP is partitioned into the three main carbon pools: leaf, wood, and root. Leaves grow and fall in a deciduous forest each year, but may last a few years in an evergreen forest. Fine woody material such as twigs and small branches may break and fall often, but tree trunks and major branches have a lifespan of decades to centuries and longer. Thus, even though wood biomass is much larger than leaf biomass, its long lifetime suggests a production rate that is much smaller than otherwise. Root biomass can be large and the death rate is also substantial as roots constantly grow to search for nutrient and water. A ‘naïve’ first guess could be that NPP is partitioned equally into these three pools, leading to a 20 GtC y⁻¹ wood growth rate, thus 20 GtC y⁻¹ wood death rate at steady state. Since fine woody debris decompose more quickly and more difficult to handle, coarser material such as trunks and major branches are more suitable for burial. Assuming half of the woody material is coarse, then about 10 GtC y⁻¹ dead wood may be available for burial, thus leading to a 10 GtC y⁻¹ carbon sink. Assuming an average residence time of 10 years for dead trees on the forest floor, about 100 GtC (10 GtC y⁻¹ times 10 years) in the form of coarse woody debris would be already on the forest floor. These dead wood materials are under various stages of decay, but even if half of that can be collected and buried, it provides a substantial readily available carbon sink.

The proposal is to (1) collect dead trees on the forest floor and (2) selectively log live trees. Then the tree trunks are either buried in the trenches dug on the forest floor (burial) or suitable landfills, or logs piled up above ground sheltered away from rain (FIG. 3). The buried woody material will have significantly longer residence time, and it effectively transfers carbon from a relatively fast decomposing pool (about 10 years) to a much slower carbon pool (100-1000 years or longer). In the case of (1), it reduces part of the heterotrophic respiration, and is thus an immediate effective carbon sink. In the case of (2), the subsequent regrowth in the ‘gaps’ left by tree cut is a carbon sink, which would depend on the rate of regrowth. In practice, (1) and (2) probably do not differ a lot, as fallen trees leave gaps for smaller trees to grow in a way very similar to case (2).

It is estimated that a sustainable long-term carbon sequestration potential for wood burial is 10±5 GtC y⁻¹, and currently about 65 GtC is on the world's forest floors in the form of coarse wooden debris suitable for burial. The potential is largest in tropical forests (4.2 GtC y⁻¹), followed by temperate (3.7 GtC y−1) and boreal forests (2.1 GtC y⁻¹). Burying wood has other benefits including minimizing CO₂ source from deforestation, extending the lifetime reforest carbon sink, and reducing the fire danger. There are possible environmental impacts such as nutrient lock-up which nevertheless appears manageable, but other concerns and factors will likely set a limit so that only part of the full potential can be realized.

Based on data from the North American logging industry, the cost of wood burial is estimated to be 14/tCO₂ ($50/tC), lower than the typical cost for power plant CO₂ capture with geological storage. The cost for carbon sequestration with wood burial is low because CO₂ is removed from the atmosphere by the natural process of photosynthesis at little cost. The technique is low tech, distributed, easy to monitor, safe, and reversible, thus an attractive option for large-scale implantation in a world-wide carbon market.

Additionally, carbon credits can be determined based on the mass of carbon dioxide sequestered, determined by the type of tree that is buried, and its dimensions, using widely available published forestry data and formulae.

In one embodiment of the disclosure, a satellite system detects fallen trees on the floor of a forest.

In another embodiment of the disclosure, a method to collect standing or down dead trees for burial or storage with minimal disturbance to the health of the forest is disclosed.

In another embodiment of the disclosure, a method to bury wood under a sufficiently thick layer of soil below the organic horizon and most of the rooting zone to avoid decomposition is disclosed.

In another embodiment of the disclosure, a manual system is used to detect fallen trees on the floor of a forest.

Another embodiment discloses a method of monitoring the condition of buried wood by the use of instrumentation or by digging up sample sites.

Another embodiment discloses a method to identify soil depth topography and hydrology for burial site selection.

Yet another embodiment discloses a method to calculate the carbon content of buried wood, by simple measurement of the geometric dimensions, using species dependent bolometric relationships and volume to carbon conversion factors.

Another embodiment of the disclosure teaches a method and modeling tool to estimate the disturbance to the forest over a sufficiently long-period of time, and the CO₂ released in using machinery, when combined with the above, gives the net CO₂ sequestered.

In yet another embodiment, a geopositioning system is used to locate the burial sites, storage location and carbon storage information in a Geographical Information System data base.

In another embodiment of the disclosure, a method to submerge wood under deep water and wetland to prevent decay, especially water bodies with minimum overturning and thus more anaerobic condition. Examples include the Black Sea and the Great Lakes.

A method for storing wood logs in sealed shelters to prevent them from decay is also taught. Such shelters are designed to prevent rain from the top, and completely sealed with resistant material also from the sides to prevent the invasion of fungi, plants, insects and animals. Any damages are fixed by periodic maintenance. The stored wood can be used in the future for lumber or biofuel.

Another method comprises a method to create a verifiable carbon accounting system that supports the practitioner of wood burial and storage to obtain carbon credits in a regional, national, or international carbon trading market.

### BRIEF DESCRIPTION OF THE FIGURES

The foregoing summary, as well as the following detailed description of preferred embodiments of the invention, will be better understood when read in conjunction with the appended drawings. For the purpose of illustrating the invention, there is shown in the drawings embodiments which are presently preferred. It should be understood, however, that the invention is not limited to the precise arrangements and instrumentalities shown.

FIG. 1: illustrates dead trees on forest floor in a natural North American deciduous forest, in Belwood, Md.;

FIG. 2: shows the Major pools and fluxes of the global carbon cycle;

FIG. 3 is a schematic diagram of forest wood burial and storage;

FIG. 4 shows the world coarse wood production rate estimated by the model VEGAS in kgC m⁻²y⁻¹;

FIG. 5 shows the world distribution of coarse woody debris, in kgC m⁻²;

FIG. 6 shows an example of a trench that could bury 500 tC, the amount of coarse wood carbon from a typical midlatitude forest area of 1 km² in 5 years;

FIG. 7 illustrates that the lifetime of buried wood can be substantially longer than fossil fuel CO₂ residence time in the atmosphere. CO₂ concentration is based on a scenario in which 1000 GtC fossil fuel is burned in the next few hundred years; and

FIG. 8 is a flow chart showing how the carbon exchange system works.

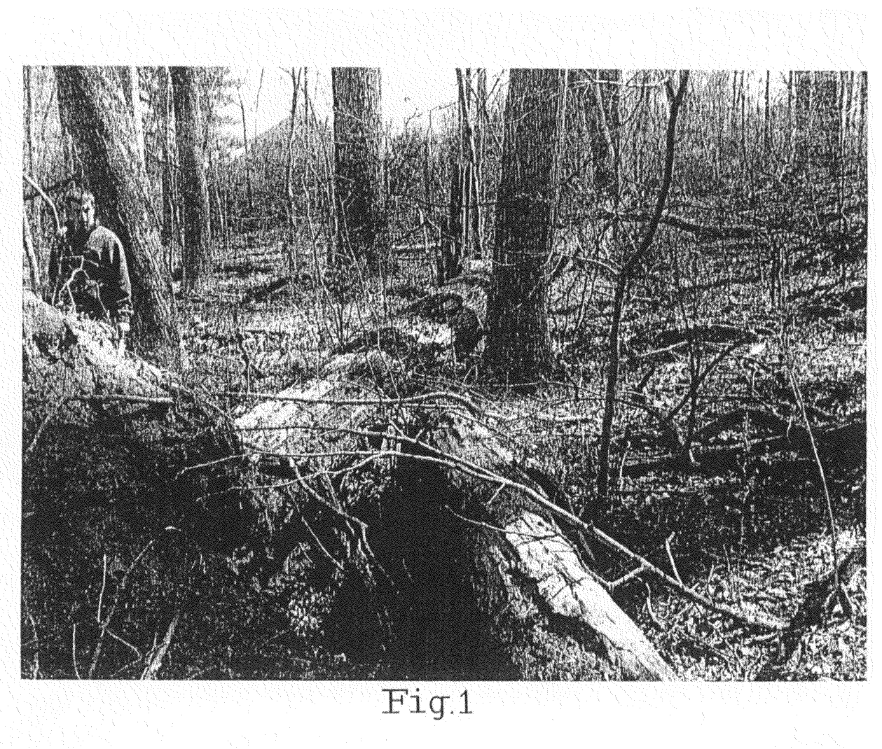

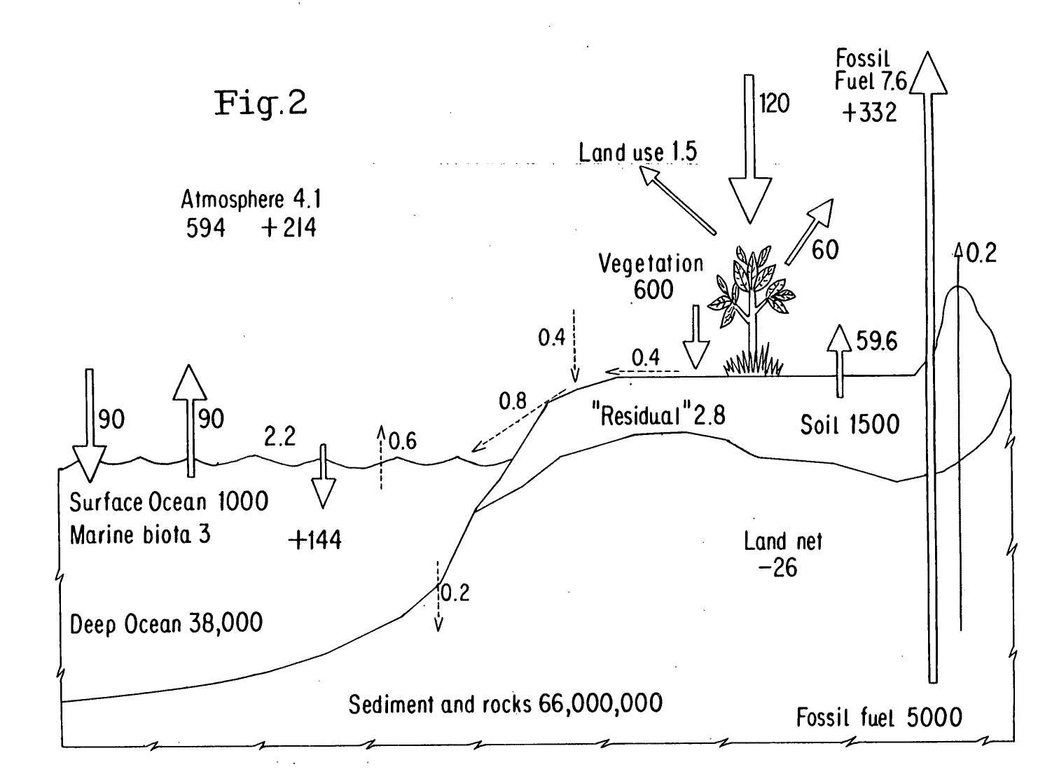

### DETAILED DESCRIPTION OF THE DISCLOSURE

To quantify the size of the potential carbon sink, the global dynamic vegetation and terrestrial carbon model VEGAS was used (Zeng, N. (2003), Glacial-interglacial atmospheric CO2 change—The glacial burial hypothesis, Advances in Atmospheric Sciences, 20(5), 677-693; Zeng, N., et al. (2004), How strong is carbon cycle-climate feedback under global warming?, Geophysical Research Letters, 31(20); Zeng, N., et al. (2005), Impact of 1998-2002 midlatitude drought and warming on terrestrial ecosystem and the global carbon cycle, Geophysical Research Letters, 32(22), all incorporated herein by reference). VEGAS simulates the dynamics of vegetation growth and competition among different plant functional types (PFTs). It includes 4 PFTs: broadleaf tree, needleleaf tree, cold grass, and warm grass. The different photosynthetic pathways are distinguished for C3 (the first three PFTs above) and C4 (warm grass) plants. Phenology is simulated dynamically as the balance between growth and respiration/turnover. Competition is determined by climatic constraints and resource allocation strategy such as temperature tolerance and height dependent shading. The relative competitive advantage then determines fractional coverage of each PFT with possibility of coexistence. Accompanying the vegetation dynamics is the full terrestrial carbon cycle, starting from photosynthetic carbon assimilation in the leaves and the allocation of this carbon into three vegetation carbon pools: leaf, root, and wood. After accounting for respiration, the biomass turnover from these three vegetation carbon pools cascades into a fast soil carbon pool, an intermediate and finally a slow soil pool. Temperature and moisture dependent decomposition of these carbon pools returns carbon back into the atmosphere, thus closing the terrestrial carbon cycle.

While the model simulates the full terrestrial carbon cycle, only the carbon pools and fluxes relevant to the purpose here are discussed. The simulation did not include agricultural land; thus, the estimates will be potential rates. The model was driven by modern observed climatology with seasonal cycles of precipitation, temperature, sunshine, wind speed, and vapor pressure. The simulation was run until convergence at a steady state where tree growth is balanced by mortality.

The modeled global NPP is 57 GtC y⁻¹, of which 19 GtC y⁻¹ goes into dead leaf, 17 GtC y⁻¹ into dead wood, and 21 GtC y⁻¹ to dead root structures. Since fine wood (twigs and small branches) decomposes quickly, is more difficult to handle (more costly to clean up the leaves, etc.), and may occupy more burial space, only coarse wood will be considered as suitable for burial. Forestry literature generally makes a distinction between fine and coarse woody debris, typically using 10 cm stem diameter to separate the two classes. Unfortunately, the relative contribution to the total wood death from fine and coarse wood is difficult to quantify, in part due to the different lifetime (smaller stems generally have shorter life than the whole tree). It is sometimes unclear how these pools and fluxes are defined and what the reported numbers represent in forestry literature. The fine:coarse ratio of death rate is roughly 7:10 so that the coarse wood death rate is 10 GtC y⁻¹.

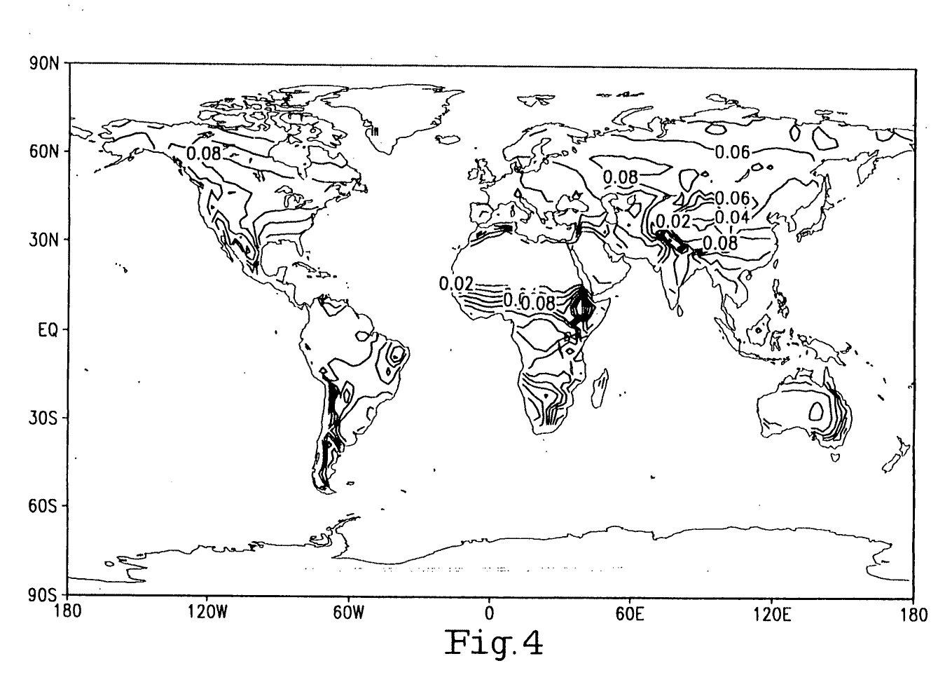

The spatial distribution of coarse wood death rate is shown in FIG. 4. The highest rate is found in the tropical rainforest such as the Amazon and the Congo basins, followed by temperate and boreal forests. The fact that the spatial distribution of wood death rate is similar to that of production (NPP) is not surprising because the death rate largely follows growth rate. Any regional deviation from the global mean partitioning ratio among the three pools (leaf:wood:root=19:17:21) is the result of plant functional type (PFT) and climate dependent carbon allocation strategy. Such deviations are no more than 10-20% in this model.

The carbon sequestration potential of coarse wood for various geographical regions is given below:

TABLE 1
Carbon sequestration potential based on coarse wood production
rate (GtC y⁻¹) estimated by VEGAS assuming potential
vegetation for the main regions of the world.

| Global | Tropics | Temperate | Boreal |
|---|---|---|---|
| 10 | 4.2 | 3.7 | 2.1 |

The tropical forest has a 4.2 GtC y⁻¹ carbon sequestration potential, temperate forest has 3.7 GtC y⁻¹, while the boreal region has 2.1 GtC y⁻¹. Since the model considers only potential vegetation (no agriculture) the temperate regions may have substantially smaller potential.

At a regional scale (Table 2),

TABLE 2
As in Table 1, but for some sub-regions (may overlap).

| N Am | US | Canada | S Am | Africa | Europe | Russia | Asia | China | SEAsia | AusNZ |
|---|---|---|---|---|---|---|---|---|---|---|
| 1.5 | 0.8 | 0.7 | 2.3 | 1.9 | 0.7 | 1.2 | 1.8 | 0.9 | 0.6 | 0.4 |

South America has a carbon sequestration potential of 2.3 GtC y⁻¹, with major contribution from the Amazon rainforest. Africa follows with 1.9 GtC y⁻¹. Russia has a potential of 1.2 GtC y⁻¹ due to its vast expanse of boreal forest. The conterminous US has a potential of 0.8 GtC y⁻¹ with its extensive broadleaf and mixed forests along the East Coast and the South, and the mountainous West. Canada has a 0.7 GtC y⁻¹ potential from its mixed and boreal forests. Of the 0.9 GtC y⁻¹ potential for China, probably only a fraction can be realized because much of the country's forests has long been converted into cropland. However, a successful reforestation program combined with wood burial and storage could boost the size of this fraction.

The coarse wood death rate estimated by the model is the result of plant functional type and climate dependent carbon allocation strategy that is not well constrained in current generation of global vegetation models (Friedlingstein, P., et al. (1999), Toward an allocation scheme for global terrestrial carbon models, Global Change Biology, 5(7), 755-770, incorporated herein by reference).

Observations on this carbon pool and its turnover rate have been generally lacking. Nonetheless, some research has emphasized the importance of this carbon pool. Using observed and estimated average tree mortality rates and extrapolating point data using global biomass distribution, (Harmon, M. E., et al. (1993), Consequences of tree mortality to the global carbon cycle, in Carbon Cycling in Boreal Forest and Sub-artic Ecosystems, edited by T. S. Vinson and T. P. Kolchugina, pp. 167-177, U.S. Environmental Protection. Agency, Washington, D.C., incorporated herein by reference) estimated the production rate of coarse woody debris to be 2-11 GtC y⁻¹, with the uncertainty range coming from the tree lifespan estimates. Based on Harmon, supra, and Matthews (Matthews, E. (1997), Global litter production, pools, and turnover times: Estimates from measurement data and regression models, Journal of Geophysical Research-Atmospheres, 102(D15), 18771-18800, incorporated herein by reference) estimated 6 GtC y⁻¹ as the coarse woody debris production rate. A comparison is listed in Table 3.

TABLE 3
A comparison of estimates of world total coarse wood production
rate (GtC y⁻¹) and coarse woody debris (GtC).

| | Harmon et | | VEGAS |
|---|---|---|---|
| | al., 1993 | Matthews 1997 | (this study) |
| Coarse wood production rate | 5 (2-11) | 6 | 10 (5-15) |
| Coarse woody debris | 60-232 | 75 | 130 |

Thus, the VEGAS model result is within the range of Harmon et al. but on the high side. One of the reasons may be that the equilibrium simulation of VEGAS implies that the modeled forests have reached a steady state, i.e., they are mature forests, while the data used include forests of different ages. Since younger forests tend to have lower mortality than old-growth ones, these young forests will have higher potential in the future as mortality rate increases towards maturity. Given the many unknowns in both methods, a factor of 2 uncertainty is assigned to the 10 GtC y⁻¹ model estimate, i.e., a range of 5-15 GtC y⁻¹.

In estimating the 10 GtC y⁻¹ potential, it is assumed that natural vegetation, which by itself would be an overestimate because some of the potential forest area has been converted to cropland. Since current world forest area is 3 times that of cropland, and a significant part of cropland corresponds to potential grassland and even desert rather than potential forest, the degree of overestimation is modest. On the other hand, the actual potential could be higher due to other factors such as selective cutting (below), planting fast growing tree species, and burying smaller-sized wood. In addition, reforestation, deforestation and climate change in the future will complicate any attempt at a precise estimate including land use. Thus, the choice in using potential vegetation was made here.

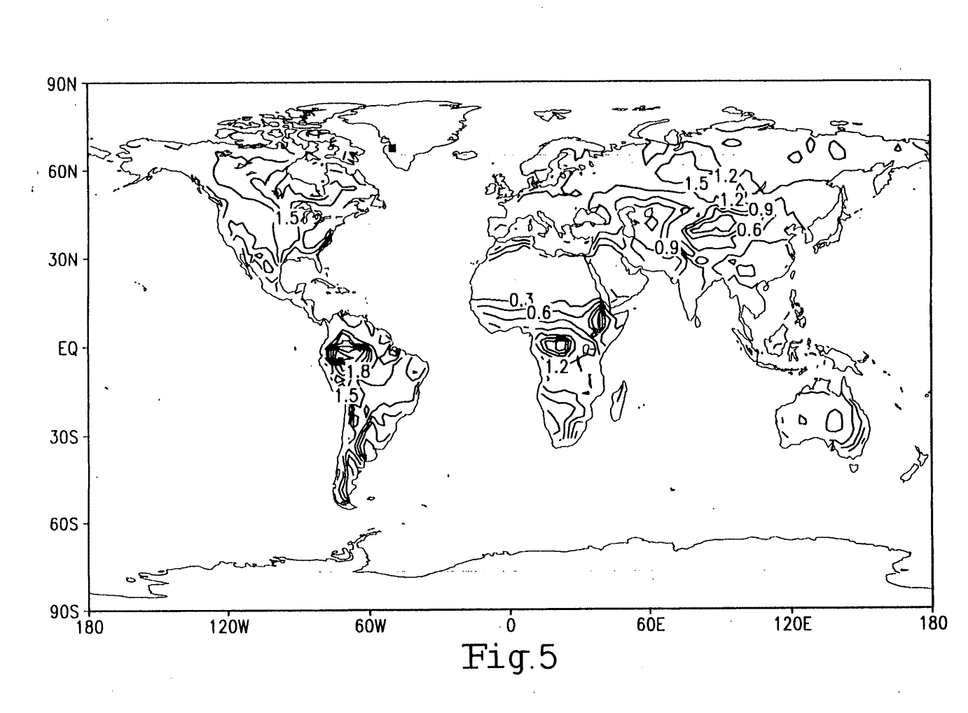

As a legacy of past tree death, a significant amount of dead wood has accumulated in the world's forests in various stages of decay (FIG. 5). The VEGAS model was used to simulate this dead wood pool and estimated global coarse woody debris to be 130 GtC, somewhat larger than the estimates of 75 GtC of Mathews, supra, but within the range of 60-232 GtC estimated by Harmon, supra. These numbers may seem large as relatively little attention has been paid to this carbon pool, but they are not surprisingly large in light of the 390 GtC stored in world's forest vegetation biomass (mostly wood; IPCC (2000), Special Report on Land Use, Land-use Change and Forestry, Cambridge University Press, incorporated herein by reference).

Since wood at later stages of decay is not suitable for burial (also less likely to be included in forest inventory studies), even if half of this pool is suitable for burial, that is still 65 GtC available for sequestration. The spatial pattern (FIG. 5) shows a somewhat different distribution from the production rate with higher values in temperate and boreal region mostly due to the slower decomposition rate at lower temperature.

The implication of this large existing carbon pool is that in the initial stage of wood burial, more than the sustainable rate of 10 GtC y⁻¹ estimated above will be available.

The first step in the process of the disclosed carbon sequestration process, as part of the carbon accounting system, is to survey the forest or land where subterranean internment of dead trees is to take place. There are principally three principle methods in which to survey the number of downed trees to be buried.

The first method does not really include a survey, but is a calculation of dead wood in an active forest. Based upon the figures given above, one can calculate the amount of dead timber, in terms of CO₂ on a forest floor in a given area. The cubic footage of dead wood can be calculated based on the average number of types of trees found in that particular type of forest. Calculations for the amount of dead wood would have to take into account the climate, geographical region, average mean temperature, spontaneous weather events (routine tornado or hurricane conditions, monsoons, etc.), the type of soil found in the region, natural vegetation, and other variables that need to be factored into any such calculation.

The low technology method comprises having a certified government or international official(or a representative of an planned carbon bank or a current member of a carbon exchange board) survey at least part of the forest or land in question in which the dead trees, and perhaps a few very large living trees, will be placed in the subterranean soil. In most cases only a small area need be surveyed in a certain geographical area or region, as generally, the number of downed trees in a specific part of the forest or land is representative and averages out over the entire area that is to be used for carbon sequestration. However, there are certain exceptions. Tornados, wind bursts, or certain other phenomena may knock down trees in a concentrated area, and specific surveys will need to be taken to survey these areas.

The in situ measurements can be supplemented by ‘top-down’ satellite or airplane measurements which can visualize, by the use of visible, infrared, photograph, laser and other techniques, the biomass on large-scale. Prior to commencement of CO₂ abatement and the burial of the dead trees, any part of any forest may be visualized and mapped by means of the satellite, with the location of the fallen wood being mapped out with the Global Positioning System. The information including amount of carbon stored, location, and age can be stored in a Geographical Information System database.

With satellites continuing to develop, it will be possible to “view” the forest floor through the canopy, and even determine the length and girth, and thus the mass, of the fallen trees.

In a certain number of cases, the entire land wherein carbon sequestration is to take place may be surveyed, when the land area is small. Measurements of the downed tree should be made, as well as noting the type of tree that has fallen and can be buried.

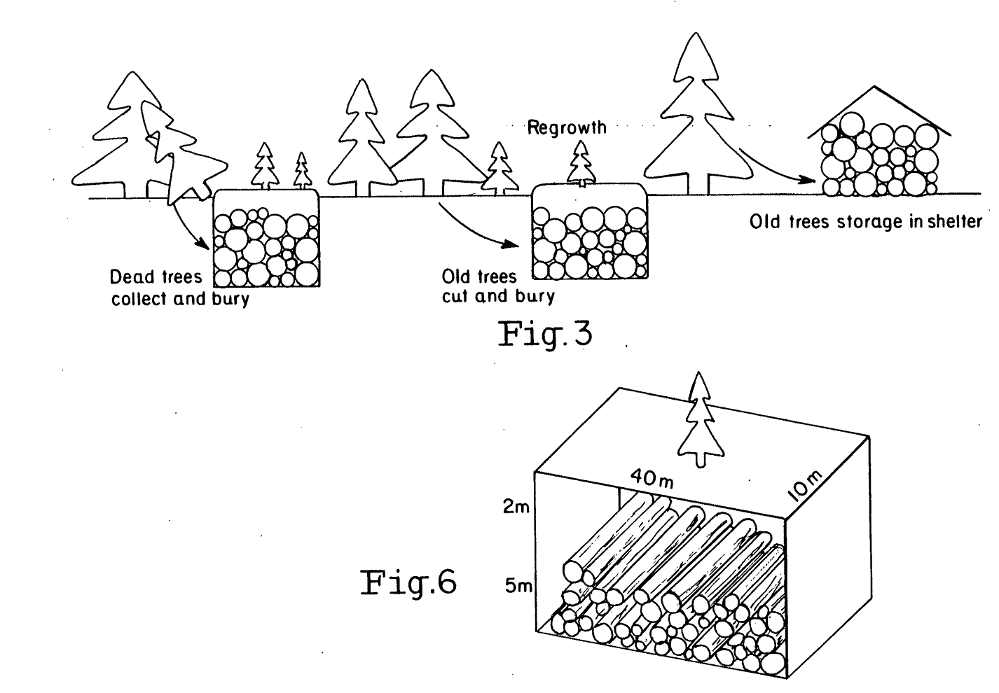

The next step in the process comprises the actual burial, or preparation for the burial of the dead wood. A series of roads and paths could be built or used that will allow machine access, and trenches could be dug and positioned uniformly through the forest area. For example, a 1 km×1 km area (100 hectares) would accumulate about 100 tonne of carbon per year for a typical coarse wood production rate of 0.1 kgC m−2 y⁻¹ (FIG. 4). At a return interval of 5 years, each trench would bury 500 tonnes of carbon (about 1000 tonne dry wood mass). Assuming a 0.5 tonne dry matter per cubic meter and neglecting some space in between the logs, the volume required would be 2000 m³. If the pile is buried under 2 meters of soil, the trench can have the dimensions of 40 m×10 m×7 m (FIG. 6). The surface area would be 400 m², only 0.04% of the wood collection area, thus the disturbance would be small. Soil will fill the space in between logs and above and be allowed to settle. Vegetation can be allowed to grow back naturally on the burial sites. Selective sites can be monitored for the decay of the buried wood. FIGS. 3 and 6 illustrate these procedures.

It should be noted that the trenches should be dug deep enough so that the dead wood is buried preferably in a clay type soil, beneath the top soil. It is also preferable that the logs be buried at least once meter below the surface of the ground, depending on the depth of the topsoil and carbon based soils. To properly prepare the site, the top soil and any carbon subsoil should be removed, and then the trench for the dead wood should be dug. The dead wood should be placed or dropped into the trench, and non carbon based soil or dirt should be used to fill in any gaps or openings between the logs and any large branches. After all of the gaps and hollows are filled, a layer of non carbonaceous dirt, in the form of clay or some other similar material, should be used to cover up the top of the logs. The dirt should be tamped down to fill any air pockets, and to limit any possibility of decomposition and release of carbon dioxide. The top soil that was originally removed can now be replaced, so that the forest can regenerate. The largely anaerobic conditions under a sufficiently thick layer of soil will prevent the decomposition of the buried wood.

It should be noted that the soil, including carbonaceous soil, can be used to fill in the air pockets; however, the dirt must be packed tightly so as to prevent oxidation, i.e., decomposition of the tree.

Not only fallen trees but very mature trees may be harvested and buried to sequester carbon dioxide. In some cases such as secondary succession where a major fraction of even aged young trees die to give way to other trees, younger trees can also be harvested and buried.

The actual trench size and distribution need to balance several factors such as cost of digging trench, transporting deadwood, minimizing disturbance to the forest, and selecting the location that most effectively prevents decomposition. Onsite burial is preferred wherever possible to minimize transportation cost. Transportation may be needed where soil is too shallow to dig trenches of sufficient depth. Since soil condition can vary greatly even within a small area such as soil moisture content variation associated with topography, care needs to be taken in site selection.

Depending on the dead wood accumulation and decay rates, this process can be repeated every few (1-10) years, but the burial sites will be different each time. The main criterion for choosing return interval will be a balance between the cost of each operation and the need not to let the dead trees rot away. If selective cutting is the main operation mode so that there is little natural tree death (trees are cut before they die), the dominant factor will be the density of suitable trees to remove. In the case of plantation, it may be a good strategy to clear cut small sections (group cutting) for its low cost, allowing trees to grow back as secondary succession.

Compared to above-ground shelter storage, trench burial is a better choice for fallen trees as they are typically already in the process of decomposition, so they are less useful as lumber wood. On the other hand, shelter storage preserves lumber wood for easy use should future demand increases.

The technology required for collecting or selectively cutting trees is low tech and has been around for thousands of years. Most modern large-scale logging is done by machines in many places such as Europe and North America. The road system for access is already in place in many of these regions such as the US ‘Forest Highway’ system. Half of the world's forests are already within 10km, and three quarters are within 40 km of major transportation infrastructure [FAO, 2001 Global Forest Resources Assessment 2000, FAO, the United Nations, Rome, incorporated herein by reference]. Since there is no major technological hurdle, such a scheme can be implemented almost immediately in a substantial fraction of these regions. For instance, a common practice in North American forestry is to hire private logging companies with a variety of operation scales to cut trees on private or public land, allowing the flexibility of handling forests of different sizes and conditions. Although currently intensely managed forests have little dead wood immediately available for burial, their long-term potential still holds.

Such a distributed system can be run with little government intervention except for monitoring, as long as economic incentive is provided through schemes such as carbon trading. In North America, much of the forested land is privately owned. The potential for carbon sequestration will have a positive impact on the logging industry and many land owners and the economy in many regions. The accounting and monitoring of the carbon sinks can be done by certified engineers when logging companies return for each round of harvest. This can be supplemented by larger-scale monitoring systems such as eddy correlation flux measurement [Baldocchi et al., 2001, FLUXNET: A new tool to study the temporal and spatial variability of ecosystem-scale carbon dioxide, water vapor, and energy flux densities, Bulletin of the American Meteorological Society, 82(11), 2415-2434, incorporated herein by reference.], source/sink inversion using atmospheric CO2 measurements [Gurney et al., 2002, Towards robust regional estimates of CO2 sources and sinks using atmospheric transport models, Nature, 415(6872), 626-630, incorporated herein by reference] assisted by future satellite CO2 observations [Rayner and O'Brien, 2001, The utility of remotely sensed CO2 concentration data in surface source inversions (vol 28, pg 175, 2001), Geophysical Research Letters, 28(12), 2429-2429, incorporated herein by reference]. The vast expanse of boreal forests in Canada and Eurasia are only partly accessible and largely unmanaged at present, but infrastructure such as roads can be built relatively quickly in the relevant countries.

If a major portion of the estimated 10 GtC y⁻¹ carbon sequestration potential is to be utilized, nearly all the world's forests will need to be managed. Then a main question would be the accessibility to the remote forest regions. Firstly, extremely steep mountainous regions or boggy wetland will be difficult to access. Secondly, there are practically no roads to the deep tropical forests. Moreover, a proposal of building a network of roads in the heart of a rainforest will raise major environmental concerns such as loss of biodiversity. On the other hand, economic incentives will continue to stimulate such road expansion. Even in this case, the issue of law enforcement for illegal deforestation, and more broad governance issues need to be first ensured before countries in these regions reach a point-of-no-return. In the near future, a beneficial practice is to bury rather than to burn the trees in the regions with ongoing deforestation.

If the cores of the tropical rainforests are to be left intact which accounts for about 20% of the total carbon sequestration potential (half of the tropical rainforest; Table 1), sequestration in the remaining tropical, temperate and boreal regions still provide a sink of 8 GtC y⁻¹. Difficulty in accessing steep terrains where forests are typically better preserved will further reduce this number. In fact, giving the cost of road construction and environmental concerns, it is desirable to manage more efficiently a smaller fraction of the available forests through methods such as selective cutting or burying part of the finer woody debris, than disturbing a larger fraction at lower per unit area carbon sequestration rate.

It should be noted that in less developed or underdeveloped areas of the world, or in environmentally sensitive areas, the dead wood can be buried by hand. In fact, since there is an overabundance of labor and an under abundance of employment, teams of men (and women can use shovels and picks to dig trenches in which to bury the dead wood. As with mechanized processes, there will be spaces and gaps between and around the dead wood. The dirt (again, as before), should be tamped down and packed tightly around the dead wood, so as to create an anaerobic condition. The dirt used should contain very little, if any top soil, and should be more of a clay based soil or a sub-top soil layer of dirt. The less carbon the dirt contains, the better. Following the packing of the dirt around the dead wood, a layer of dirt should be used to cover the dead wood. This dirt should not be top soil, but should be a clay based soil that has a limited amount of carbon. A layer of top soil is then placed on top of the sub soil, so that grass, crops, other trees, etc., may be grown.

Subterranean deposit is not the only methodology that can be used for carbon sequestration from dead wood.

It is also possible to sequester carbon from dead wood aboveground, with the use of storage shed that prevents rain and light from entering, thereby preventing the growth of fungi, bacteria, and other microorganisms to grow. The shelters would be scattered throughout the forest, and it would be most advisable to seal the entire stack of dead wood in thick plastic or other resistant material to prevent attacks by fungi, insects, plants and animals. The doors and windows (if any) would be sealed. The dead wood might be in a container that is packed with clay soil to create a totally anaerobic condition. Any damages are fixed by periodic maintenance. The stored wood can be used in the future for lumber or biofuel.

Another method to preserve wood is to submerge wood under deep water and wetland to prevent decay, especially water bodies with minimum overturning and thus more anaerobic condition. Examples include the Black Sea and the Great Lakes.

Because of the low oxygen condition below soil surface, the decomposition of buried wood is expected to be slow. This is supported by the observation of extremely slow decomposition of woody material such as furniture in landfills where wood products are found to be well preserved after many years of burial by Micales and Skog (Micales, J. A., and K. E. Skog (1997), The decomposition of forest products in landfills, International Biodeterioration & Biodegradation, 39(2-3), 145-158, incorporated herein by reference). Indeed, these authors found that only 0-3% of the carbon from wood are ever emitted as landfill gas after several decades, and considered the remaining fraction locked away ‘indefinitely’. Ancient wood can be preserved for thousands of years in undisturbed archeological sites. Indeed, the current proposal can be viewed as creating ‘graveyards’ for dead trees worldwide. In the boreal forests where the temperature is low, decomposition can be very slow as evidenced by tree trunks hundreds of years old on the boreal forest floor. Since decomposition rate is also function of moisture, the burial sites need to be chosen properly in consideration of local topography and hydrology. If needed, the decomposition could be further slowed by sealing the outer layer with resistant material such as wax. It is also possible to bury dead wood in wetlands or under water, but there will be major. transportation cost, availability of suitable sites, and permanence issue in face of human activities and climate change.

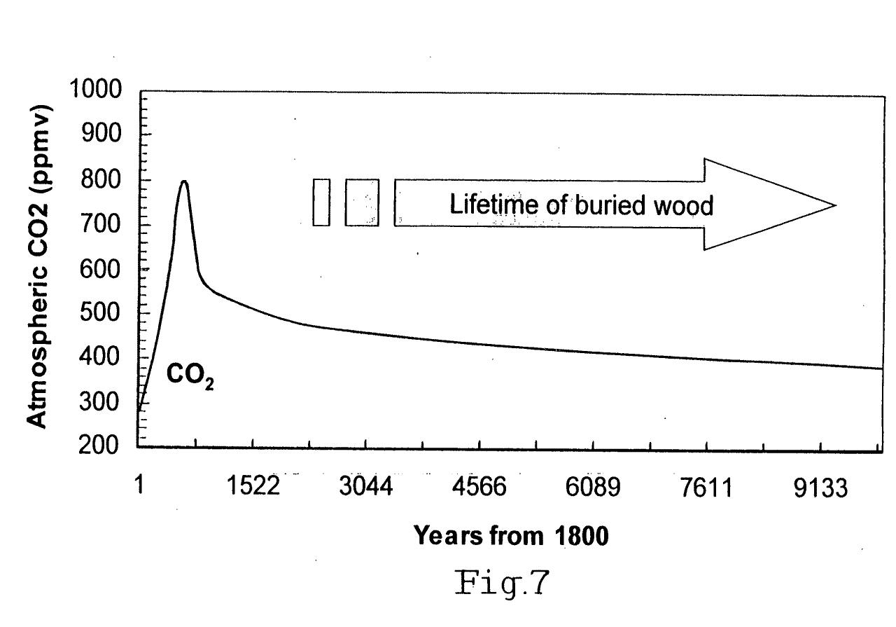

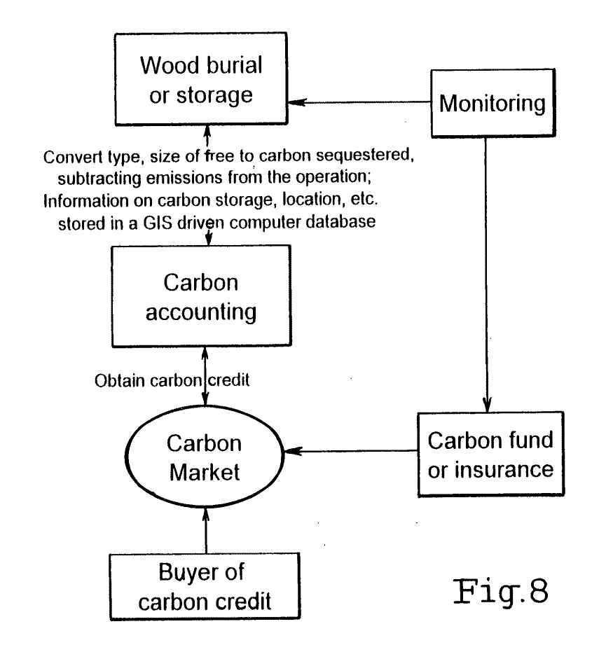

The 0-3% range of decomposition rate [Micales and Skog, infra] translates into an e-folding timescale of 1000 years to infinity, assuming a 30 year average age for landfills in their survey. If these burial sites are better protected through, e.g., thicker soil cover, the preservation would last even longer. Thus, the decomposition rate of collected wood can be slowed down at least to the timescale of 1000 years (most likely longer) so that the release of this buried carbon pool is negligible compared to forest regrowth uptake in response to collection/cutting that occur on the timescales of decades. If the buried carbon comes out slowly over the timescale of thousands of years, it should have already passed the major peak of atmospheric CO₂ as the anthropogenic CO₂ ‘pulse’ is absorbed into the deep ocean and the carbonate sediments as shown in FIG. 7 (Archer, D., et al. (1997), Multiple timescales for neutralization of fossil fuel CO₂, Geophysical Research Letters, 24(4), 405-408, incorporated herein by reference).

Depending on the burial depth, the deep roots of trees re-growing on some burial sites may eventually invade into the trench and facilitate the decomposition of buried wood so that the nutrient and carbon will slowly return to the surface and the atmosphere. Although the vegetation could be made not to re-grow above the trench, or the buried wood could be insulated from the top soil by a layer of resistant material, re-growth might be more desirable than ‘permanent’ burial (tens of thousands of years or longer). Thus the way wood is buried will determine the decomposition rate, and can be managed to desired effect. Long term monitoring and research of representative sites will be useful for finding optimal burying methods.

Once the wood is buried, or secured in an above ground shelter, or even underwater, it is helpful to get an accounting or verification that the dead wood in a given geographical area has, in fact been placed in an anaerobic condition. There are several methods that can be used to determine whether in fact wood has been buried or secured under anaerobic conditions.

The first methodology comprises self reporting system for determining the amount of dead wood that has been buried in a given area. Currently, in Western style economies, logging companies record the amount of wood that is cut from the forest. Similarly, these same companies can manually or by internet report the amount of dead trees that have been put into anaerobic conditions. Alternatively, a computerized system or manual system can be used by anyone who has secured trees in an anaerobic condition. However, to prevent fraud, it is important that the individuals or companies who are reporting on their efforts at carbon sequestration be pre-registered in a carbon sequestration program. The location of the site can be entered into the computer by the GPS coordinates, so that there is no “double counting” of the carbon credits. If the computer is handheld, the project may be entered on-site, and the system can determine the site of burial using a GPS system.

Upon registration of the amount (length, width, type of tree) of dead wood that was buried, a central computer can calculate the amount of carbon sequestered, and this figure could be stored in a computer cyberbank, preferably run by an international quasi-governmental body, whereupon the client could draw down on the account by balancing the amount of carbon sequestered versus the amount of carbon dioxide produced. Alternatively, an account can be established, whereby moneys are received from companies and countries buying carbon credits. The account could be a cash account, whereby cash is either given at the time of deposit, or at the time of purchase of the carbon credits. A fraction of this should go into a ‘carbon insurance’ or ‘carbon fund’ to insure against any possible future loss of the stored wood due to natural or man-made causes such as fire, theft. The insurance rate should be determined based on the risk of the specific burial or storage method, location and other factors. The cost or price of the carbon credits can be determined by the Chicago or European Carbon Exchanges. Alternatively, the transactions can be made directly with the Chicago or European Carbon Exchanges.

The second methodology comprises using a GPS satellite to compare the forest or wooded area prior to placing the dead wood in an anaerobic condition, with the condition of the forest following burial. It should be noted that present public technology does not generally allow the satellite to “see” through the tree canopy; however, such a technology (and the corresponding satellite could be developed in the future.

Once the GPS and other data is recorded, carbon credits can then be awarded based on a computerized comparison of the forest floor prior to and after the burial of the dead wood, determined by an electronic photoanalysis and by the measurement of the ground topography. The GPS satellite can then send a signal to an international carbon bank, or the European or Chicago carbon exchange(s). The signal can transfer information as to the “depositor,” (name, address, wire account of depositor) location of wood storage, amount of carbon sequestered, etc.). In return, depending on the instructions of the depositor, the carbon bank will credit the current market cash value of the deposit can be credited to the account, or a check may be mailed directly to the depositor. In an alternative embodiment, the carbon credits can remain in the account and exchanged for cash at the depositor's will when the value of the carbon credits rise. The value of the carbon credits rise when there is a greater demand for carbon credits, primarily from corporations whose operations add carbon dioxide to the air. Hence, when the economy is strong, the value of carbon credits will be greater, because factories are operating at full or nearly full capacity, and thus are producing carbon dioxide. When the economy is weak, such as during a recession or a depression, factory output drops, some factories close, there is less carbon dioxide produced, and thus there is less demand for carbon credits.

The accounts may be set up automatically either when the first survey of dead wood is taken, or when the amount of sequestered dead wood is reported. An account name and a password can also be set up, to prevent tampering.

In an additional embodiment, a governmental or institutional representative can verify the information being provided by spot checking the area in which it is claimed carbon sequestration took place.

In some instances, the areas may be too primitive or too poor to accommodate a computer link. In those circumstances, a designated official (governmental, non-governmental, World Bank, United Nations, or appointed individual, etc.) can visit the site where sequestration steps as described above took place, record the data, transmit the data through the appropriate channels, infra, and see that the moneys to be paid are either deposited in the appropriate accounts, or distributed to those involved in the sequestering of the carbon. The level of involvement by a third party is dependent on the sophistication of those involved in the actual coordination and sequestration of carbon. Those in developed nations, such as in Europe, Australia, Japan, and North America, will have greater knowledge and access to computers, than primitive tribes in South America and Africa, who, ironically, would most benefit from the proposed carbon sequestration program than people in developed countries.

Another method for reporting the sequestering of carbon by the burial of dead wood involves reporting the results on paper, recording the GPS coordinates, and submitting the results by mail or in person to a reporting center. Accounts can also be set up via mail or by the reporting center.

Given the importance of accuracy, routine, periodic, or random reviews of carbon sequestration sites can be made by designated officials, who can be chosen from government officials, private citizens, non-governmental organizations, etc.

The scale of the climate change problem dictates that any mitigation strategy, whether being alternative energy source, carbon sequestration technique, or geo-engineering approach, has to be cost effective when operated on a large scale. Data from the US logging industry indicate that a typical cost for harvesting 1 tonne of lumber wood is about $20 [Visser, 2007, Timber Harvesting (Logging) Machines and Systems, edited, incorporated herein by reference]. Lumber wood is only part of the coarse woody material that can be buried, which is (assumed to be) about 50% more than lumber wood alone (there are substantial amount of smaller branches compared to the trunk). Additionally, given that lumber wood contains some water and that plant dry mass is approximately 50% carbon, the cost could be $40 per tonne of sequestered carbon. This would be higher if the cost of trench digging, road construction and maintenance is included. Thus, one can liberally put the cost of lumber sequestration at about at $50 for 1 tC (tonne or 10⁶ gram of carbon) sequestered, with an uncertainty range of $25-$100/tC.

It is illuminating to compare this with power plant CO₂ capture and geological storage, a strategy that has been under intense study [IPCC, 2005, supra].

TABLE 4
Comparison of wood burial and power plant CCS. The markets use tCO₂ as carbon
unit which can be converted into tC with the conversion factor the molecular
weight ratio CO₂:C = 44:12; both units are shown.

| | | Price on Chicago | European carbon |
|---|---|---|---|
| | Power plant CO₂ capture | Climate Exchange | trading market price |
| Wood Burial | with geological storage | (CCX) 2006 | during 2005-2007 |
| $14/tCO₂ ($7-27) | $20-270/tCO₂ [IPCC, 2005] | $3-4/tCO2 | [symbol] 1-33/tCO₂ |
| $50/tC ($25-100) | $73-990/tC | $12-16/tC | [symbol] 4-120/tC |
| Storage safe; semi- | Possibility of leakage; lower | | |
| permanent, reversible; | cost storage capacity small | | |
| some environmental | | | |
| concern | | | |
| Potential: 10 ± 5 GtC y⁻¹ | Potential rate is limited by | | |
| Long-term: thousands of | scale of operation | | |
| GtC or no practical limit | Longterm: >500 GtC | | |

The $50/tC ($14/tCO₂) cost for wood burial is lower than the $20-270/tCO₂ for power plant CCS. The large range in power plant CCS is due to the increasing cost as cheaply available old mines run out. In the case of wood burial, there is no practical storage capacity limitation. A major cost of industrial CCS is the capturing of CO₂ from flu gas, while wood burial is free air capture with near-zero cost because it is done by the natural process of photosynthesis.

It is also interesting to compare this cost with the pioneering European Union Emission Trading System (EUETS) carbon cap-and-trade market price. The EUETS price has fluctuated between ε1-33/tCO₂ during 2005-2007. In comparison, the voluntary Chicago Climate Exchange (CCX) price has been around $3-4/tCO₂. Although the wood burial cost is somewhat higher than the current market price, it is expected that future climate mitigation policy will result in higher prices for carbon.

Even if only half of the estimated potential (5 GtC y⁻¹) is carried out in the next few decades, say, by 2050, the scale of such a world-wide operation would be enormous, as illustrated in the scenario below.

If each trench has a 500 tC capacity (example in FIG. 6), then the number of trenches needed for a 5 GtC y⁻¹ sequestration rate would be 10 million per year, i.e., one trench every 3 seconds. Assuming it takes a crew of 10 people (with machinery) one week to dig a trench, collect/cut and bury wood over a 100 hectare area, 200,000 crews (2 million workers) and sets of machinery would be needed. This estimate is admittedly simplistic and the task could be quite labor-intensive if it is to be carried out in dense or steep-sloped natural forests.

The scale of such an operation may be difficult to imagine at first sight, but the enormous scale of the CO₂ problem means that any effective mitigation strategy also has to be at a comparable scale. The current rate of 8 GtC y⁻¹ fossil fuel carbon emission rate corresponds to 250 tC per second. Since carbon content of wood is roughly the same as in fossil fuel, if wood burial is to counteract the fossil fuel emission (as it could potentially do), the rate (in terms of either mass or volume) at which wood is buried needs to be comparable to the rate we burn fossil fuel. If wood burial is used as part of a portfolio, the operation could be scaled down accordingly.

The plausibility of this operation may be more easily comprehended from an economical point of view. A $50/tC cost for wood burial corresponds to $250 billion per year at a 5 GtC y⁻¹ sequestration rate. This is only 0.5% of world total Gross Domestic Product (GDP) of $48 trillion in 2006, compared to the projected 5-20% GDP potential economic damage from climate change [Stern, 2007, supra]. The $250 billion per year cost for 2 million workers means $62,500 per worker, assuming half is for machinery and other costs. Obviously, labor and machine costs can be very different in different countries. The job opportunities provided by the operation and other positive impact on the economy will be attractive in many regions especially the developing countries.

It should be noted that the burial of dead wood has a number of additional benefits. Fire suppression, such as in the US and Canada over last several decades, has left a large amount of dead vegetation on the forest floor and contributed to an apparent carbon sink in North America. This additional fuel load, combined with recent drought in the America West has led to more frequent and large fires in recent years. The release of this carbon pool through catastrophic fires may become an important source to atmospheric CO₂ in the future. Collecting dead trees and burying them would reduce fire danger while creating a carbon sink. By reducing the number of forest fires, less carbon dioxide is released into the atmosphere. Similarly, this method can be applied to other sudden deaths of trees due to, e.g., hurricane blowdown and insect infestation.

Additionally, in South America, deforestation often leads to the burning of numerous tons of dead trees, creating a greater problem of carbon release. The burying of these dead trees will limit the amount of carbon release into the atmosphere.

Many modifications and variations of the present disclosure are possible in light of the above teachings. It is, therefore, to be understood within the scope of the appended claims the invention may be protected otherwise than as specifically described.

What is claimed is:

1) A method for sequestering carbon, said method comprising:
a) surveying a given area for dead and suitable live wood;
b) identifying said dead wood;
c) placing said dead wood in an anaerobic environment such that there is virtually no release of carbon dioxide from said dead wood.

2) The method according to claim 1, wherein the amount and type of dead wood is recorded prior to step c.

3) The method according to claim 1, wherein said dead wood is buried in the ground in an anaerobic condition, in a layer of soil beneath the layers of carbon based soil.

4) The method according to claim 1, wherein said dead wood is buried in an anaerobic condition, in an above ground shelter, said shelter being sealed.

5) The method according to claim 1, further comprising recording type and amount of said dead wood prior to burial.

6) The method according to claim 5, further comprising reporting data comprising the amount of sequestered carbon to a central authority.

7) The method according to claim 6, wherein said central authority is a carbon exchange.

8) The method according to claim 6, wherein said central authority is a carbon bank.

9) The method according to claim 5, further comprising reporting the amount of said dead wood that has been buried to a central authority.

10) The method according to claim 5, further comprising receiving saleable carbon credits based on the amount of carbon that has been sequestered.

11) The method according to claim 8, further comprising receiving money upon sale of said carbon credits.

12) The method according to claim 6, wherein said reporting of said is performed by means of computer communication.

13) The method according to claim 8, further comprising receiving money based on the amount of carbon sequestered.

14) The method according to claim 1, further comprising harvesting overly mature trees and placing harvested said mature trees in an anaerobic environment or sealed shelters such that there is virtually no release of carbon dioxide from said mature trees which have been harvested.
